(19) United States
(12) Patent Application Publication
(10) Pub. No.: US 2009/0112615 A1
(43) Pub. Date: Apr. 30, 2009

(54) METHOD AND APPARATUS FOR DISPLAYING AND ORGANIZING CLINICAL INFORMATION OF A PATIENT

(75) Inventor: Christopher Janicki, Sleepy Hollow, IL (US)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, Schenectady, NY (US)

(21) Appl. No.: 11/932,163

(22) Filed: Oct. 31, 2007

(51) Int. Cl. G06Q 10/00; G06F 19/00; G06Q 50/00

(52) U.S. Cl. 705/2

(57) ABSTRACT

Certain embodiments of the present invention provide a system and method for displaying clinical information. The system includes a computer unit for executing computer software for a graphical user interface application. The graphical user interface application displays a plurality of clinical information types. The clinical information types are organized into groups of graphical representations of a plurality of folders. In an embodiment, the clinical information types are represented by different shapes. In an embodiment, the plurality of folders is displayed as stacks of folders. In an embodiment, each folder visually represents the amount of information contained in that folder. For example, the vertical displacement of the folder may correspond to the amount of information contained in that folder. In another example, the vertical displacement of said folder may correspond to the amount of information contained in that folder that has not been reviewed by a user.

### BACKGROUND OF THE INVENTION

The present invention generally relates to a system and method for organizing the clinical information of a patient. Particularly, the present invention relates to an intuitive graphical user interface to organize patient information.

Medical diagnostic imaging systems encompass a variety of imaging modalities, such as x-ray systems, computerized tomography (CT) systems, ultrasound systems, electron beam tomography (EBT) systems, magnetic resonance (MR) systems, and the like. Medical diagnostic imaging systems generate images of an object, such as a patient, for example, through exposure to an energy source, such as x-rays passing through a patient, for example. The generated images may be used for many purposes. For instance, internal defects in an object may be detected. Additionally, changes in internal structure or alignment may be determined. Fluid flow within an object may also be represented. Furthermore, the image may show the presence or absence of objects in an object. The information gained from medical diagnostic imaging has applications in many fields, including medicine and manufacturing.

The information gained from medical diagnostic imaging systems may be part of a patient's clinical information. The clinical information of a patient may include imaging information, notes, diagnosis, test results, prescriptions, health care providers and other medically related information regarding the health care of a patient. Over the course of time, the clinical information of a patient may become voluminous and difficult to manage.

### SUMMARY OF THE INVENTION

Certain embodiments of the present invention provide a system and method for displaying clinical information. The system includes a computer unit for executing computer software for a graphical user interface application. The graphical user interface application displays a plurality of clinical information types. In an embodiment, the clinical information types may include examinations, medical imaging scans, or notes. The clinical information types may be organized into groups of graphical representations of a plurality of folders. In an embodiment, the clinical information types are represented by different shaped folders. In an embodiment the plurality of folders are displayed as stacks of folders. In an embodiment the folder visually represents the amount of information contained in that folder. In an embodiment, the visual representation includes changing the vertical displacement of said folder corresponding to the amount of information contained in that folder. In an embodiment, the visual representation includes changing the vertical displacement of said folder corresponding to the amount of information contained in that folder that has not been reviewed by a user. In an embodiment, the visual representation includes changing the color of part of said folder corresponding to the amount of information contained in that folder that has not been reviewed by a user. The system may also include a display unit for displaying said graphical user interface application. The system may also include an input unit for receiving input from a user.

Certain embodiments of the present invention provide a method for displaying clinical information. The method includes displaying the available clinical information for a patient as a plurality of clinical information types. The clinical information types are organized into groups of graphical representations of a plurality of folders. The method also includes optionally displaying a preview window showing a preview of the information contained in a folder. The preview window being displayed when a user manipulates the computer mouse pointer over the folder. In an embodiment, the preview window is displayed partially over said folder. The method further includes receiving the selection of one of the plurality of folders, the selection being made by a user. The method further includes displaying the contents of the selected folder. The method optionally includes receiving a command to copy information from the selected folder to a second folder. In an embodiment, the command to copy information is a drag-and-drop command to drag information from the selected folder and drop information into a second folder.

Certain embodiments of the present invention include a computer-readable storage medium including a set of instructions for a computer. The set of instructions includes a first display routine for displaying the available clinical information for a patient as a plurality of clinical information types. The clinical information types may be organized into groups of graphical representations of a plurality of folders. The set of instructions optionally includes a preview routine for displaying a preview window showing a preview of the information contained in a folder. The preview window being displayed when a user manipulates the computer mouse pointer over said folder. In an embodiment, the preview window is displayed partially over said folder. In an embodiment the preview window is displayed for a fixed period of time when a user manipulates the computer mouse over the folder. The set of instructions also includes a second receipt routine for receiving a command to copy information from the selected folder to a second folder. In an embodiment, the command to copy information is a drag-and-drop command to drag information from the selected folder and drop information into a second folder.

### BRIEF DESCRIPTION OF THE DRAWINGS

FIG. 1 illustrates a system in accordance with an embodiment of the present invention.

FIG. 2 illustrates a graphical user interface application representing the clinical information available for a hypothetical Patient A in accordance with an embodiment of the present invention.

FIG. 3 illustrates a method in accordance with an embodiment of the present invention.

### DETAILED DESCRIPTION OF THE INVENTION

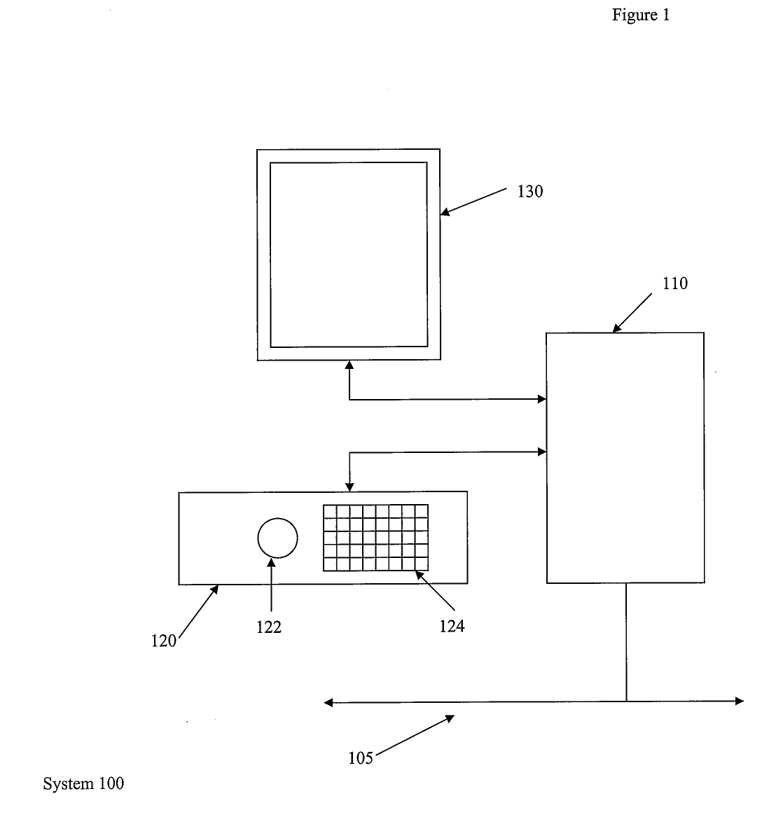

FIG. 1 illustrates a system 100 for reviewing medical images. The system 100 includes a computer unit 110. The computer unit 110 may be any equipment or software that permits clinical information such as electronic medical images, for example, x-rays, ultrasound, CT, MRI, gated MRI, EBT, MR, or nuclear medicine for example, to be electronically acquired, stored, or transmitted for viewing and operation. The clinical information may also include information such as notes, diagnosis, test results, prescriptions, health care providers and other medically related information regarding the health care of a patient. The computer unit 110 may receive input from a user. The computer unit 110 may be connected to other devices as part of an electronic network. In FIG. 1, the connection to the network is represented by line 105. The computer unit 110 may be connected to network 105 physically, by a wire, or through a wireless medium. In an embodiment, the computer unit 110 may be, or may be part of, a picture archival communication system (PACS).

The system 100 also includes an input unit 120. The input unit 120 may be a console having a track ball 122 and keyboard 124. Other input devices may be used to receive input from a user as part of the input unit 120. For example a microphone may be used to receive verbal input from a user. The system 100 also includes at least one display unit 130. The display unit 130 may be a typical computer display unit. The display unit 130 may be in electrical communication with the computer unit 110 and input unit 120. In an embodiment, the display unit 130 may represent multiple display units or display regions of a screen. Accordingly, any number of display units may be utilized in accordance with the present invention.

In an embodiment, the system 100 is a PACS with display unit 130 representing the display unit of PACS. The computer unit 110 may represent equipment and components of a PACS system other than the display unit. The computer unit 110 and display unit 130 may be separate units or be part of a single unit. In the case of separate units, the display unit 130 may be in electrical communication with the computer unit 110. The components of the system 100 may be single units, separate units, may be integrated in various forms, and may be implemented in hardware and/or in software.

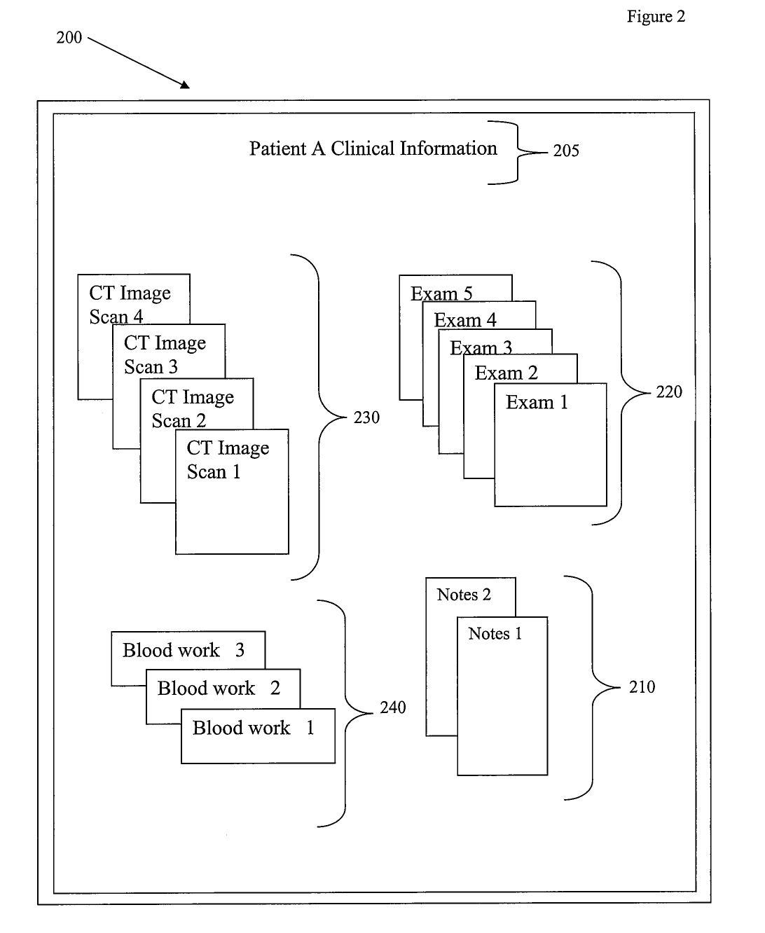

FIG. 2 illustrates a graphical user interface application 200 representing the clinical information available for a hypothetical Patient A which may be used with the system 100 in accordance with an embodiment of the present invention. The graphical user interface application 200 illustrates graphical components for displaying and organizing the clinical information of a patient. The display unit 130 of the system 100 is shown along with graphics 205, 210, 220, 230, and 240 displayed on the display unit 130. In the embodiment shown, graphic 205 identifies the patent as Patient A and the context of the information shown as clinical information. The types of clinical information shown in FIG. 2 are only examples and any types of clinical information may be displayed. Also, the types of organization shown in FIG. 2 are only examples and other types of organization may be used.

Graphics 210, 220, 230, and 240 organize types of clinical information for Patient A. For example, graphic 210 illustrates the available notes that have been accumulated for Patient A. The notes 210 may contain notes from a physician or other entity. The notes 210 may be organized by date, subject, exam, procedure, or any other organizational scheme. Also shown on the graphical user interface application 200 is graphic 220. Graphic 220 illustrates, for example, the available exams for Patient A. The exams 220 may include information acquired during each of the exams. The exams 220 may be organized according to date, priority of condition, or other technique for organizing data. Graphic 230 illustrates, for example, the available CT image scans for Patient A. The CT image scans 230 may include information acquired during each CT image scan for Patient A. The CT image scans may be organized by priority of condition, date, or other technique for organizing data. Graphic 240 illustrates, for example, the available blood work 240 for Patient A. The blood work 240 illustrates information regarding the information available for the blood work of Patient A. The blood work information 240 may be organized by priority of condition, date, or other technique for organizing data.

As shown in the embodiment of the graphical user interface application 200, the graphics 210, 220, 230, and 240 include an orthographic view of stacked file folders representing types of clinical information for Patient A. The stacks may be organized according to user selected criteria, for example, modality, exam date, priority, completed exams, or any other qualifier for organizing information. In an embodiment, the height of each stack visually represents the amount of information, such as number of exams in each category. Also, in an embodiment, different types of information may be represented by different shaped folders. For example, folders of graphic 210, representing clinical notes information are longer vertically than horizontally. Folders of graphic 240, representing clinical blood work information, are longer horizontally than vertically. In an embodiment, the folders of the graphical user interface may be shaped differently according to clinical information type, date, priority, or other organizational technique to further allow a more intuitive user experience.

A user may also drag and drop information between the various stacks, mouse-over the exams to view a detailed description pop up of exam information and click to open exams in the viewports. In an embodiment, after information in a folder is reviewed, the respective stack height may be visually reduced to represent the amount of review performed and the amount of review remaining. In another embodiment, the stack may change appearance, such as color or transparency, to represent the amount of review performed and the amount of review remaining. In such a manner, a visual representation of the available clinical information of a patient and a visual representation of a work queue may be displayed.

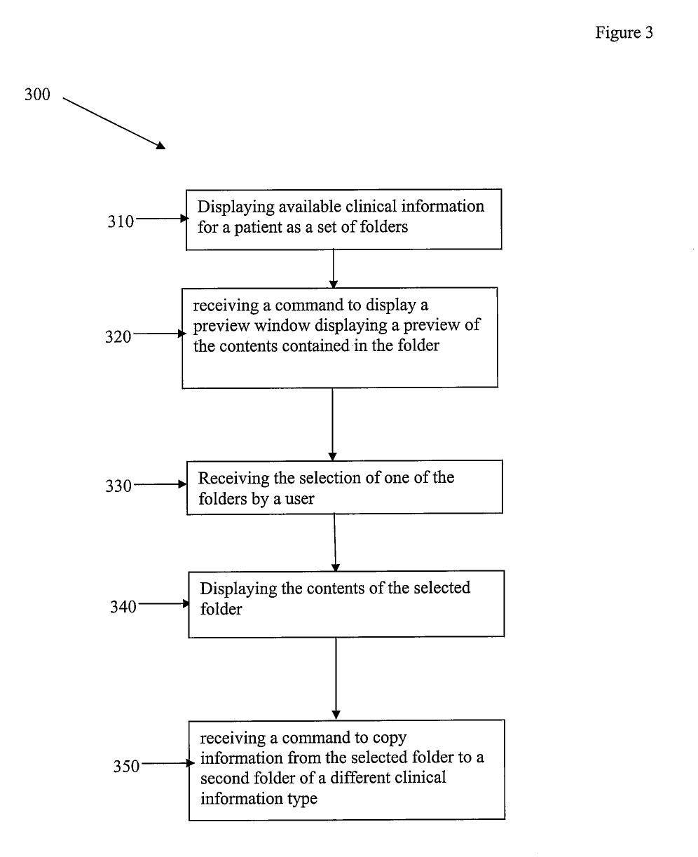

FIG. 3 illustrates a method 300 in accordance with an embodiment of the present invention. At step 310, available clinical information for a patient is displayed by computer software as a set of folders. In an embodiment, the available clinical information may be organized into an orthographic view of stacked file folders representing types of clinical information for a particular patient. The stacks may be organized according to user selected criteria, for example, modality, exam date, priority, completed exams, or any other qualifier for organizing information. In an embodiment, the height of each stack visually represents the amount of information, such as number of exams in each category. Also, in an embodiment, different types of information may be represented by different shaped folders. In addition, at step 320, the computer software optionally receives a command to display a pop up window displaying a preview of information contained in a folder. For example, a user may mouse-over the folders to view a preview description in a pop-up window of the information displayed in that folder. In an embodiment, the preview window is displayed for a fixed period of time when a user manipulates the computer mouse pointer over the folder. At step 330, the selection of one of the folders by a user is received by computer software. A user may select one of the folders to display the contents of that folder. In an embodiment, the user may select one of the folders by clicking on the folder with a computer mouse. At step 340, the computer software may display the contents of the selected folder. At step 350, the computer software optionally receives a command to copy information from the selected folder to a second folder of a different clinical information type. For example, a user may drag and drop information between the various stacks of information.

The system and method described above may be carried out as part of a computer—readable storage medium including a set of instructions for a computer. The set of instructions includes a first display routine for displaying the available clinical information for a patient as a set of folders. In an embodiment, the available clinical information may be organized into an orthographic view of stacked file folders representing types of clinical information for a particular patient. The stacks may be organized according to user selected criteria, for example, modality, exam date, priority, completed exams, or any other qualifier for organizing information. In an embodiment, the height of each stack visually represents the amount of information, such as number of exams in each category. Also, in an embodiment, different types of information may be represented by different shaped folders. The set of instructions may include a preview routine for previewing the information in a folder in a preview window. In an embodiment, a user may mouse over a folder and a preview window may by displayed showing information about the contents of the folder. In an embodiment, the preview window is displayed for a fixed period of time when a user manipulates the computer mouse pointer over the folder. The set of instructions may also include a selection routine for selecting one of the folders displayed to a user. In an embodiment, a user may select one of the folders using a computer mouse. The set of instructions may also include a second display routine for displaying the contents of the selected folder. The set of instructions may include a transfer routine for transferring information from a selected folder to a second folder.

Certain embodiments of the present invention provide a technical effect of displaying clinical information for a patient and organizing the patient's clinical information on an intuitive graphical user interface. Certain embodiments provide an orthographic view of stacked file folders representing types of clinical information. A user may select a folder to display the contents of the folder. A user may drag and drop information among folders and stacks of information. In an embodiment, after information in a folder is reviewed, the respective stack height may be visually reduced to represent the amount of review performed and the amount of review remaining. In another embodiment, the stack may change appearance, such as color or transparency, to represent the amount of review performed and the amount of review remaining. In such a manner, a visual representation of the available clinical information of a patient and a visual representation of a work queue may be displayed.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A system for displaying clinical information, said system comprising:
a computer unit for executing computer software for a graphical user interface application, said graphical user interface application displaying a plurality of clinical information types, the clinical information types organized into groups of graphical representations of a plurality of folders;
a display unit for displaying said graphical user interface application; and,
an input unit for receiving input from a user.

2. The system of claim 1, wherein one of said clinical information types is examinations.

3. The system of claim 1, wherein one of said clinical information types is medical imaging scans.

4. The system of claim 1, wherein one of said clinical information types is notes.

5. The system of claim 1, wherein said plurality of folders are displayed as stacks of folders.

6. The system of claim 5, wherein the folder visually represents the amount of information contained in that folder, said visual representation includes changing the vertical displacement of said folder corresponding to the amount of information contained in that folder.

7. The system of claim 5, wherein the folder visually represents the amount of information contained in that folder that has not been reviewed by a user, said visual representation includes changing the vertical displacement of said folder corresponding to the amount of information contained in that folder that has not been reviewed by a user.

8. The system of claim 5, wherein the folder visually represents the amount of information contained in that folder that has not been reviewed by a user, said visual representation includes changing the color of part of said folder corresponding to the amount of information contained in that folder that has not been reviewed by a user.

9. The system of claim 1, wherein the clinical information types are represented by different shaped folders.

10. A method for displaying clinical information, said method comprising:
displaying the available clinical information for a patient as a plurality of clinical information types, the clinical information types organized into groups of graphical representations of a plurality of folders;
receiving the selection of one of the plurality of folders, said selection being made by a user; and,
displaying the contents of the selected folder.

11. The method of claim 10, further comprising displaying a preview window showing a preview of the information contained in a folder, said preview window being displayed when a user manipulates the computer mouse pointer over said folder, wherein said preview window may be displayed after displaying the available clinical information and before selecting one of the plurality of folders.

12. The method of claim 11, wherein said preview window is displayed partially over said folder.

13. The method of claim 10, further comprising receiving a command to copy information from the selected folder to a second folder.

14. The method of claim 13, wherein said command to copy information is a drag-and-drop command to drag information from the selected folder and drop information into a second folder.

15. A computer-readable storage medium including a set of instructions for a computer, the set of instructions comprising:
a first display routine for displaying the available clinical information for a patient as a plurality of clinical information types, the clinical information types organized into groups of graphical representations of a plurality of folders;
a first receipt routine for receiving the selection of one of the plurality of folders, said selection being made by a user; and,
a second display routine for displaying the contents of the selected folder.

16. The set of instructions of claim 15, further comprising a preview routine for displaying a preview window showing a preview of the information contained in a folder, said preview window being displayed when a user manipulates the computer mouse pointer over said folder, wherein said preview window may be displayed after displaying the available clinical information and before selecting one of the plurality of folders.

17. The set of instructions of claim 16, wherein said preview window is displayed partially over said folder.

18. The set of instructions of claim 17, wherein said preview window is displayed for a fixed period of time when a user manipulates the computer mouse over said folder.

19. The set of instructions of claim 15, further comprising a second receipt routine for receiving a command to copy information from the selected folder to a second folder.

20. The set of instructions of claim 18, wherein said command to copy information is a drag-and-drop command to drag information from the selected folder and drop information into a second folder.
